(19) United States
(12) Patent Application Publication
(10) Pub. No.: US 2005/0105386 A1
(43) Pub. Date: May 19, 2005

(54) Mixing paddle for cooling a mixture

(76) Inventors: Regina Kay Crites, Sparks, NV (US); Van G. Tipton, Reno, NV (US)

Correspondence Address: KUNZLER & ASSOCIATES, 8 EAST BROADWAY, SALT LAKE CITY, UT, 84111, US

(21) Appl. No.: 10/784,400

(22) Filed: Feb. 23, 2004

Related U.S. Application Data
(60) Provisional application No. 60/449,302, filed on Feb. 21, 2003.

(51) Int. Cl. F25D 25/00; B01F 15/06; A23B 4/08; A23B 4/14; A23B 4/12; F25D 3/08

(52) U.S. Cl. 366/147; 62/530; 99/517

(57) ABSTRACT

An apparatus, system, and method are provided for cooling a mixture using a mixing paddle. The mixing paddle includes a shaft that is configured to connect to a mixer. The shaft, in one embodiment, connects to a blade that comprises a hollow cavity, and a refrigerant is sealed within the hollow cavity. The mixing paddle may be chilled to change the thermal state of the refrigerant to a temperature below that of a mixture. The chilled paddle may be connected to a mixer and used to mix the mixture. The refrigerant in the hollow cavity absorbs thermal energy from the mixture, thereby reducing the temperature of the mixture.

### RELATED APPLICATIONS

This application is a continuation-in-part of and claims priority to U.S. Provisional Patent Application No. 60/449,302, filed on Feb. 21, 2003 and entitled “A MIXING COOLING PADDLE.”

### BACKGROUND OF THE INVENTION

1. Field of the Invention

The invention relates to cooling devices. Specifically, the invention relates to cooling devices for use with powered, ingredient mixers.

2. Description of the Related Art

In industrial kitchens, often large quantities of food are prepared in a single batch. The food products are generally heated to prepare the food; then chilled to serve or store the food. Unfortunately, bacteria growth can occur during the cooling process, especially if food is kept at a moderate temperature for extended periods of time. To prevent foodborne illnesses, the FDA has imposed regulations that require commercial foods to be cooled to 41° F. within six hours. In addition, a more stringent regulation, the Hazard Analysis Critical Control Point (HACCP), stipulates that foods be cooled to 45° F. within four hours. However, these cooling requirements set by government agencies are often difficult to meet. Industrial kitchens have been searching for efficient, cost-effective methods to cool food quickly.

One method currently in use is to separate a large, single batch of food, such as a large bowl of mashed potatoes, for example, into smaller bowls. The smaller portions of food can then be placed on a shelf or in a refrigerator to cool. Because the smaller portions have a greater surface area, thermal energy is transferred to the surrounding environment more rapidly than if the food remains in one large container.

Though separating food into smaller portions to cool is functional, this method creates many problems. First of all, food still cools relatively slowly and not always within the imposed regulations. Also, providing a greater surface area of food product could mean providing a greater area for bacteria growth, for uneven cooling, and for drying or condensation damage that can occur during refrigeration. Secondly, separating the food requires many dishes that take up valuable kitchen storage space. Plus, when the food is ready to be used, food left on the various dishes is wasted and unusable. Furthermore, additional kitchen workers are required to scrape and clean the dishes.

Other kitchens use ice packs or refrigerant gel packs to cool food internally in an attempt to prevent surface damage. This method is still problematic, though, because the packs must be placed into the food product. Spot cooling still occurs, so a user must manually stir the food product to evenly distribute the cooled portions. With the cooling packs in the product, mixing the food is nearly impossible.

Another method recently developed to meet government regulations is to cool food in a blast chiller. A blast chiller is similar to a high powered refrigerator or freezer. The equipment, likewise, is large, complex, and unreasonably expensive. The blast chiller cools food quickly, but a user still must stir the food so cooling occurs evenly throughout the product. Also, the user may have to put the food item into a separate container that fits into the blast chiller. Consequently, such a device cools a food product quickly, but creates additional problems as well, such as high expense, additional manual labor, and limited kitchen space.

Other cooling devices known in the art offer a mixing, cooling combination. Unfortunately, such devices are often complex, expensive, occupy a significant amount of room, and require frequent maintenance. These devices are often dedicated solely to mixing and cooling a mixture and are incompatible with other equipment. Regular mixers generally include accessories such as beaters, dough hooks, wire whips, and the like and are designed to perform multiple functions. Mixing, cooling devices, however, generally circulate a gas or fluid throughout a mixing member to provide a cooled surface to contact the product being mixed. As a result, the devices are often bulky, requiring complex components, yet still have limited functionality because the mixing members are not interchangeable.

FIG. 1 is a conceptual block diagram that illustrates a cooling apparatus 100 available in the market. The cooling apparatus 100 comprises a mixing machine 102, a container 104, and an agitator 106, similar to other mixing devices available in the market. A mixture 108 is placed into the container 104 to be cooled and mixed by the agitator 106. To cool the surface of the agitator 106, a pump 110 circulates a fluid from the fluid reservoir 112 through the agitator 106 via a fluid passage 114. The circulating fluid allows thermal energy to be transfer from the mixture 112 to the fluid. To cool the fluid, certain embodiments of the cooling apparatus 100 may also include a compressor 116.

The components of the cooling apparatus 100, unfortunately, are complex and expensive. The intricate parts can malfunction and cause problems for the user, which can be costly to repair. Also, because the fluid passage 114 and other delicate parts are connected to the agitator 106, the agitator 106 may not be removable. Consequently, the agitator 106 may not be interchangeable, and the user may have difficulty removing the mixture 108 from the container 104. Furthermore, the mixing machine 102 is not compatible with other equipment. As a result, the cooling apparatus 1100 is only functional to cool and mix a mixture 108. In addition, the user may be required to maintain the fluid levels in the equipment, which may be a time-consuming and bothersome process.

Accordingly, a need exists for an apparatus, system, and method for cooling a mixture with an improved mixing paddle that is simple and inexpensive. The apparatus, system, and method should cool a mixture using a static coolant that does not include complex equipment such as fans, pumps, compressors, and the like. In addition, the apparatus, system, and method should be a closed, or sealed, system that does not require maintenance of fluids or fluid lines. Further the apparatus, system, and method should function as both a mixer and a cooling device that is easily portable, washable, adapts to existing kitchen equipment, and can be used to control the rate of cooling of a mixture.

### BRIEF SUMMARY OF THE INVENTION

The present invention has been developed in response to the present state of the art, and in particular, in response to the problems and needs in the art that have not yet been met for cooling a mixture. Accordingly, the present invention has been developed to provide an apparatus, system, and method for cooling a mixture using a mixing paddle that overcomes many or all of the above-discussed shortcomings in the art.

An apparatus according to the present invention includes a mixing paddle for cooling a mixture that comprises a shaft configured to connect to a mixer and a blade connected to the shaft. The blade comprises a hollow cavity and a refrigerant sealed within the hollow cavity. The hollow cavity may extend into the shaft. In addition, the mixing paddle may comprise a universal adapter formed in the shaft. The universal adapter is preferably configured to interchangeably connect to a mixer.

The refrigerant sealed in the hollow cavity is preferably in a state capable of absorbing thermal energy by conduction. The refrigerant may be in a state selected from the group consisting of a solid, a liquid, and a gas. Accordingly, the hollow cavity may be sized to accommodate expansion of the refrigerant during state phase changes.

The mixing paddle may further comprise a monitoring device to monitor the thermal condition of the refrigerant. In one embodiment, the monitoring device comprises a thermometer. In a further embodiment, the monitoring device may be a window configured to show the refrigerant within the hollow cavity.

A system for cooling a mixture comprises a mixer, a container for holding a mixture, and a mixing paddle configured to cool the mixture. The mixing paddle includes a shaft configured to connect to the mixer, a blade having a hollow cavity, and a refrigerant sealed within the hollow cavity.

A method for making a mixing paddle to cool a mixture comprises forming a first mixing paddle half and a second mixing paddle half. Next, the first mixing paddle half and the second mixing paddle half are joined to form a mixing paddle. The mixing paddle includes a hollow cavity. In addition, the mixing paddle may further include an opening in the hollow cavity. Then, a refrigerant is sealed within the hollow cavity.

In one embodiment, the hollow cavity is filled with a refrigerant through the opening in the hollow cavity. Then, the opening is permanently or openably closed to seal the refrigerant. Additionally, a window configured to show the refrigerant within the hollow cavity may be formed in the mixing paddle.

A method for using a mixing paddle to cool a mixture comprises providing a mixing paddle having a shaft configured to connect to a mixer, a blade comprising a hollow cavity, and a refrigerant sealed within the hollow cavity. Next, a mixing paddle may be selected from a plurality of mixing paddles such that the refrigerant in the hollow cavity is configured to provide a predetermined rate of cooling. Then, the mixing paddle may be placed in a cooling apparatus.

When a mixture needs to be cooled, the mixing paddle may be removed from the cooling apparatus and connected to a mixer. The mixer may then mix the mixture with the mixing paddle. The temperature of the mixture may be periodically monitored until a desired temperature is reached. In addition, the thermal condition of the refrigerant may also be monitored.

If the mixture is not sufficiently cooled by the first mixing paddle, the mixing paddle may be replaced with a second mixing paddle. Preferably, the second mixing paddle has a refrigerant in a state capable of absorbing additional thermal energy from the mixture.

The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a conceptual block diagram illustrating a cooling apparatus of the prior art;

FIG. 2 is a conceptual block diagram illustrating one embodiment of a system of the present invention for cooling a mixture;

FIG. 3 is a cross-sectional view of a mixing paddle in accordance with one embodiment of the present invention;

FIG. 4 is a cross-sectional view of an alternative embodiment of a mixing paddle of the present invention;

FIG. 5 is a cross-sectional view of another embodiment of a mixing paddle of the present invention;

FIG. 6 is a flow chart diagram illustrating a method for making a mixing paddle to cool a mixture according to one embodiment of the present invention; and

FIG. 7 is a flow chart diagram illustrating a method for using a mixing paddle to cool a mixture according to one embodiment of the present invention.

### DETAILED DESCRIPTION OF THE INVENTION

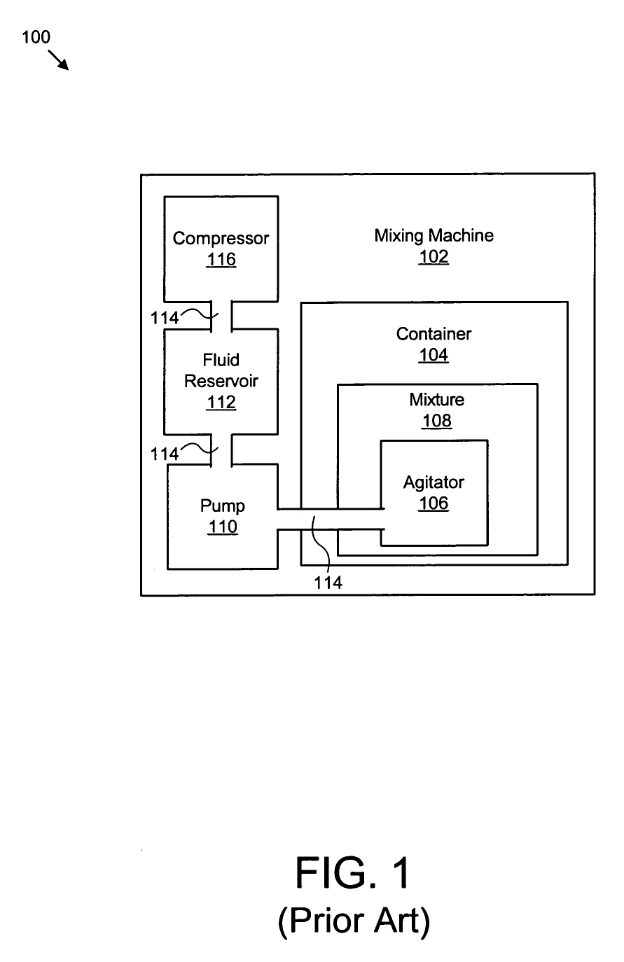

It will be readily understood that the components of the present invention, as generally described and illustrated in the figures herein, may be arranged and designed in a wide variety of different configurations. Thus, the following more detailed description of the embodiments of the apparatus, system, and method of the present invention, as presented in FIGS. 1 through 7, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

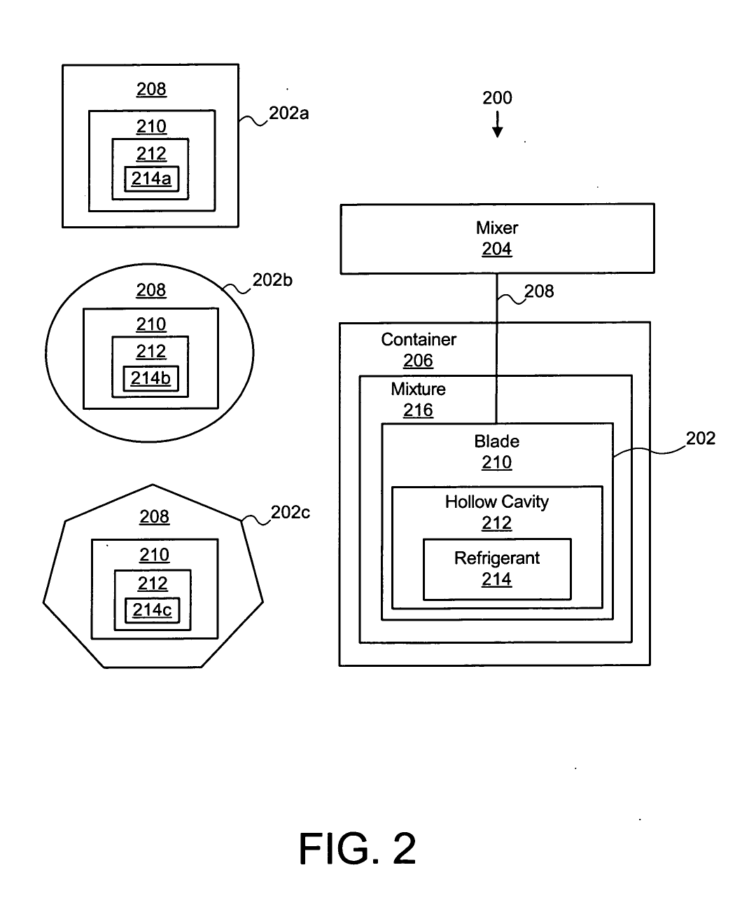

FIG. 2 illustrates a system 200 for cooling a mixture with a mixing paddle 202. The system 200 comprises a mixer 204, a container 206, and a mixing paddle 202. The mixer 204, in one embodiment, is a commercial mixer currently available in the food industry market. The container 206 may also be a container known in the art, such as a bowl configured to function with the mixer 204. In an alternative embodiment, the mixer 204 may be a smaller mixer designed for home use.

The present invention provides a mixing paddle 202 that may function similar to a beater or dough hook used in conjunction with the mixer 204. The mixing paddle 202 includes a shaft 208, a blade 210 having a hollow cavity 212, and a refrigerant 214 sealed within the hollow cavity 212. Preferably, the mixing paddle 202 may be chilled to reduce the temperature of the refrigerant 214 within the mixing paddle 202.

The shaft 208 is preferably configured to connect to the mixer 204. A universal adapter may be formed in the shaft to allow the shaft 208 to interchangeably connect to the mixer 204. Furthermore, the blade 210 may be connected to the shaft 208. Alternatively, the blade 210 may be integrated with the shaft 208. In such an embodiment, the hollow cavity 214 may extend from the blade 210 into the shaft 208. Accordingly, the refrigerant 214 may fill the hollow cavity 214 in both the blade 210 and the shaft 208.

The blade 210 is configured to be inserted into a mixture 216. The mixture 216 may be a viscous material or food item that requires cooling. As mentioned, the blade 210 preferably includes a hallow cavity 212 to contain a refrigerant 214. The refrigerant 214 absorbs thermal energy from the mixture 216 by conduction.

To facilitate absorption of thermal energy, the blade 210 may be made from a temperature conducting material. Contemplated materials may include metal, plastic, and the like. Preferably, the temperature conducting material is resilient and can withstand rapid changes in temperature. In certain embodiments, the blade 210 may be made of a clear plastic to allow a user to view the refrigerant 214. In an alternative embodiment, the mixing paddle 202 may include a window configured to show the refrigerant within the hollow cavity 212.

The refrigerant 214 may be any material that is capable of absorbing thermal energy from the mixture 216. Preferably, the refrigerant 214 has less thermal energy than the mixture 216. In certain instances, a refrigerant 214 may be a fluid material, such as water, alcohol, glycerol, glycol, and the like. Alternatively, the refrigerant 214 may be a gas, a liquid, a semi-solid, or a solid. In select embodiments, the refrigerant may undergo various state phase changes. For example, water may be frozen into a solid, and then melted back into a liquid. Preferably, the hollow cavity 212 is sized to accommodate expansion of the refrigerant during state phase changes.

The refrigerant 214 used may be selected to control the rate of cooling of a mixture 216. By selecting a mixing paddle 202 with a certain refrigerant 214 and/or a certain surface area, a user can control the amount of thermal energy the mixing paddle 202 absorbs.

Mixing paddles 202a-c illustrate alternative embodiments of mixing paddles 202 with various shapes and containing various refrigerants 214. For example, a mixing paddle 202a with a large surface area and a large hollow cavity 212 filled with a frozen refrigerant gel 214a may have a higher cooling potential than a smaller mixing paddle 202b filled with semi-frozen water 214b. As a result, a user may choose a larger, colder paddle 202a to cool a mixture 216 quickly. Alternatively, the user may employ a smaller mixing paddle 202b to cool a mixture 216 when a slower rate of cooling is desired.

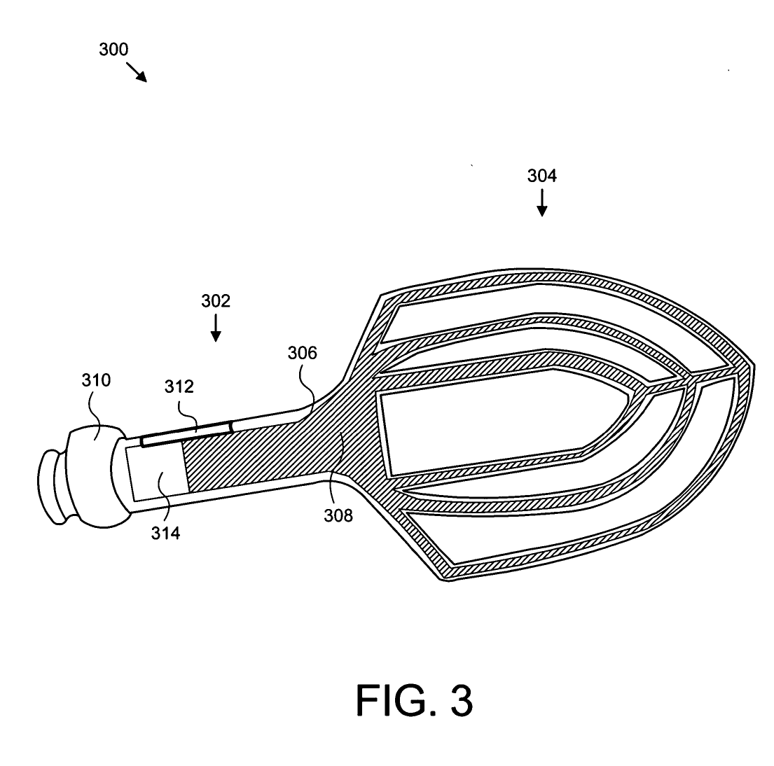

FIG. 3 illustrates one embodiment of a mixing paddle 300 for cooling a mixture 216 (See FIG. 2). The mixing paddle 300 includes a shaft 302, a blade 304, a hollow cavity 306, and a refrigerant 308 sealed within the hollow cavity 306. The blade 304 is connected to the shaft 302 with the hollow cavity 306 extending from the blade 204 into the shaft 302.

The mixing paddle 300 further comprises a universal adapter 310 integrated with the shaft 302. The adapter 310 permits the mixing paddle 300 to be interchangeably connected to a variety of mixers 204. Preferably, the adapter 310 is compatible with existing kitchen equipment. Consequently, a user may effectively cool a mixture 216 without purchasing expensive or bulky equipment that has no function other than to cool a mixture 216. The paddle 300 is simple and self-contained, requiring little maintenance. In addition, the paddle 300 is easily stored and may be used by a single individual.

To assist a user in selecting a mixing paddle 300, the mixing paddle 300 may further include a monitoring device 312 to monitor the thermal condition and/or state of a refrigerant 308. Consequently, the user may be able to determine how the mixing paddle 300 may affect a mixture 216 as briefly discussed above.

In the depicted embodiment, the monitoring device 312 comprises a window configured to show the refrigerant 308 within the hollow cavity 306. To monitor the thermal state of the refrigerant 308, a user can look through the window 312 to check whether the refrigerant 308 is in a liquid, solid, or gaseous state. Thus, the user may judge whether the refrigerant 308 is capable of absorbing additional thermal energy from the mixture 216. For example, thermal energy can be absorbed from a mixture 216 more easily by a mixing paddle 300 containing a frozen refrigerant material with less thermal energy than by a mixing paddle 300 containing a liquid form of the same refrigerant material.

By using the monitoring device 312, when the refrigerant 308 is no longer capable of effectively absorbing thermal energy from the mixture 216, the user may replace the mixing paddle 300 in the mixer 204 with a second mixing paddle 300 that is capable of absorbing additional thermal energy from the mixture 216. Consequently, the user can substantially control the amount of thermal energy that is transferred from the mixture 216 to a refrigerant 308.

As mentioned previously, the refrigerant 308 may undergo frequent phase changes. The refrigerant 308 may be in a state selected from the group comprising a solid, a liquid, and a gas. Consequently, the hollow cavity 306 may be sized to accommodate expansion of the refrigerant 308 during state phase changes. To allow expansion, the hollow cavity 306 may include space 314 for expanding refrigerant 508. As a result, the mixing paddle 300 may be chilled and heated repeatedly without requiring the user to change or replace the refrigerant 308.

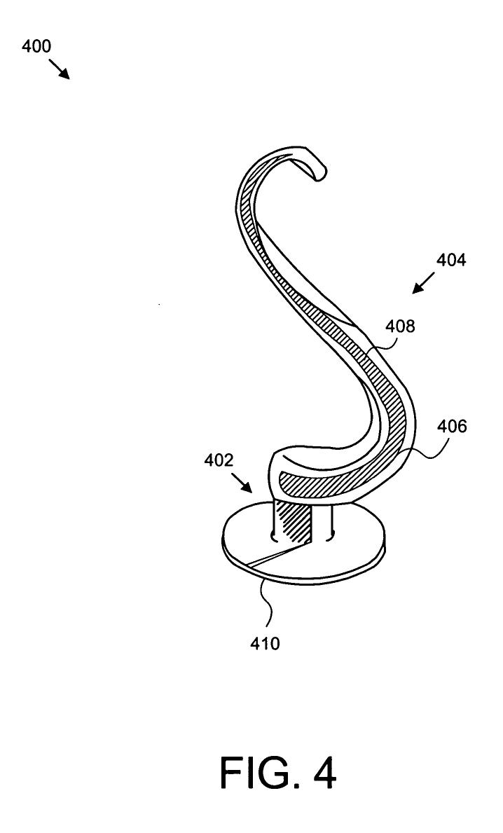

FIG. 4 illustrates an alternative embodiment of a mixing paddle 400. The mixing paddle 400 includes a shaft 402, a blade 404, a hollow cavity 406, and a refrigerant 408 sealed within the hollow cavity 406. The hollow cavity 406 may be formed in the blade 404 only and may not extend into the shaft 402. The shaft 402 is preferably connected to an adapter 410 that connects to a mixer 204 (See FIG. 2).

The blade 404 is shaped, in one embodiment, like a bread hook. Accordingly, the mixing paddle 400 may be used to cool mixtures 216 with a high viscosity. In certain embodiments, the mixing paddle 400 may be used to maintain the temperature of a mixture 216 during mixing. Mixing highly viscous mixtures 216 can generate thermal energy caused by friction, which, accordingly, increases the temperature of the mixture 216. The increased temperature can be damaging to certain mixtures 216. For example, mixing bread dough with a mixer 204 may be damaging to the yeast and may adversely affect the final food product.

To prevent over-heating a mixture 216, a user may mix a mixture 216 with a cool mixing paddle 400. The refrigerant 408 may maintain a cool temperature for mixing, even though the mixture 216 may be exposed to room temperature conditions and heat caused by the mixing equipment.

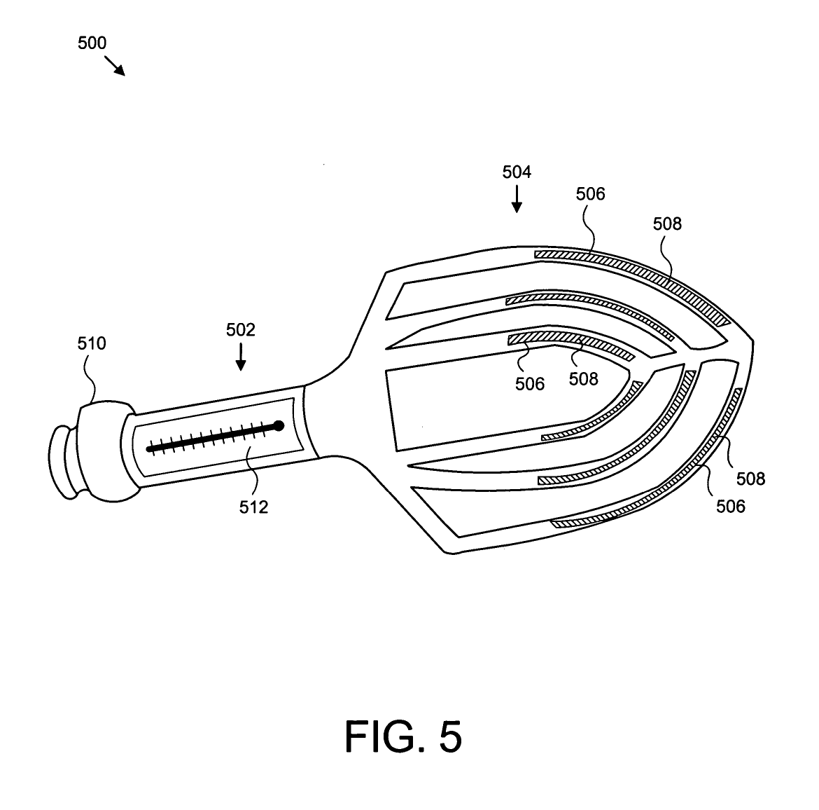

FIG. 5 illustrates a further embodiment of a mixing paddle 500. The mixing paddle 500 comprises a shaft 502, a blade 504, a plurality of hollow cavities 506, and a refrigerant 508 sealed within the hollow cavities 506. The mixing paddle 500 may further comprise a universal adapter 510 and a monitoring device 512.

In the depicted embodiment, the monitoring device 512 is a thermometer, which may be in contact with the refrigerant 508. The monitoring device 512 allows a user to place a mixing paddle 500 into a cooling apparatus, such as a freezer, and monitor the temperature of the refrigerant 508 until the refrigerant 508 has reached a desired temperature. Then, the user may remove the paddle 500 from the cooling apparatus and connect the paddle 500 to a mixer 204 (See FIG. 2). The mixer 204 may be used to mix a mixture 216 with the chilled paddle 500. As the refrigerant 508 absorbs thermal energy from the mixture 216, the user may periodically monitor the temperature of the refrigerant 508 with the thermometer 512.

As mentioned previously, the temperature or thermal state of the refrigerant 508 may indicate the need to replace a mixing paddle 500 with a second mixing paddle 500 that is in a state capable of absorbing additional thermal energy from the mixture 216. In this way, a mixture 216 may be completely cooled to a desired temperature.

Additionally, in one embodiment, the hollow cavities 506 may contain various refrigerants 508. For example, one hollow cavity 506 may contain water, while another hollow cavity 506 may contain alcohol. The use of different refrigerants 508 in the hollow cavities 506 may be predefined based on thermal dynamics to provide the best possible cooling method for various mixtures 216. In certain situations, a slower transfer of thermal energy from the mixture may be more advantageous than a rapid transfer of energy.

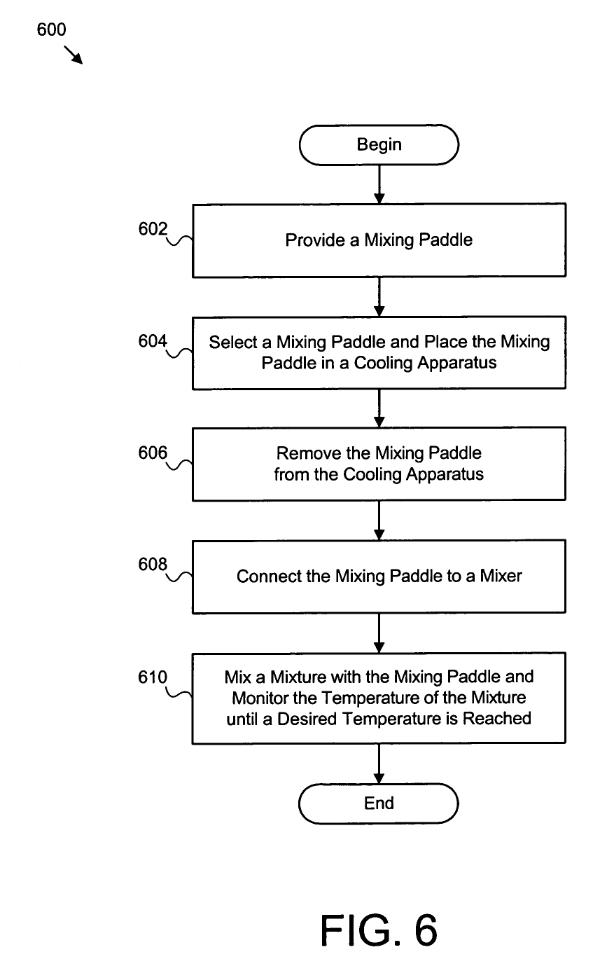

FIG. 6 is a flow chart diagram illustrating a method 600 for using a mixing paddle 202 to cool a mixture 216 (See FIG. 2). The method 600 begins by providing 602 a mixing paddle 202. Next, a mixing paddle 202 may be selected 604 and placed in a cooling apparatus, such as a freezer. Alternatively, the mixing paddle 202 may be stored in a cooling apparatus for use when needed. When the refrigerant 214 cools to a desired temperature, the mixing paddle 202 may be removed 606 from the cooling apparatus and connected 608 to a mixer 204.

As mentioned, the user may select a mixing paddle 202 that is most suitable for cooling a particular mixture 216. In certain instances, a user may store a plurality of mixing paddles 202 in a freezer, or other appropriate cooling apparatus. Consequently, when a mixing paddle 202 is needed, a user may select a chilled paddle 202 from among various types of chilled paddles 202 stored in the freezer.

For example, a user may have a large batch of mixture 216 that needs to be cooled. Consequently, the user may select a large mixing paddle 202a containing a frozen refrigerant gel 214a from the plurality of mixing paddles 202 stored in the freezer. Alternatively, the user may choose to use a smaller paddle 202b containing water 214b to mix a smaller batch of mixture 216. In that case, the user would select the smaller paddle 202b from the plurality of paddles 202 stored in the freezer.

Once the mixing paddle 202 is connected to the mixer 204, the mixer 204 mixes 610 the mixture 216 with the mixing paddle 202. The temperature of the mixture 216 may be monitored until a desired temperature is reached. When the mixture 216 reaches a desired temperature, the method 600 ends.

Additionally, the user may replace the mixing paddle 202 in the mixer 204 with a second mixing paddle 202 if the mixture 216 does not reach a desired temperature before the mixing paddle 202 is no longer capable of absorbing additional thermal energy from the mixture 216. Preferably, the second mixing paddle 202 is in a state capable of absorbing additional thermal energy from the mixture 216.

Also, a monitoring device 312, 512 (FIG. 3 and FIG. 5) may be used to determine the thermal condition of the refrigerant 214. For example, if a user selects a mixing paddle 202b with water 214b sealed in the hollow cavity 212, a monitoring device 312, 512 may be used to determine if the water is frozen. In one embodiment, a user may look through a window 312 to view the state of the water. Accordingly, the user may determine that the water 214b has melted completely. Then the mixing paddle 202b may be replaced with a mixing paddle 202 that contains a frozen refrigerant 214, if the mixture 216 requires further cooling.

When a mixing paddle 202 has been used to cool a mixture 216, the paddle 202 may be easily washed and returned to the freezer or other cooling apparatus. In this manner, a user may reuse a mixing paddle 202 repeatedly. The mixing paddles 202 are simple, inexpensive, and easy to maintain.

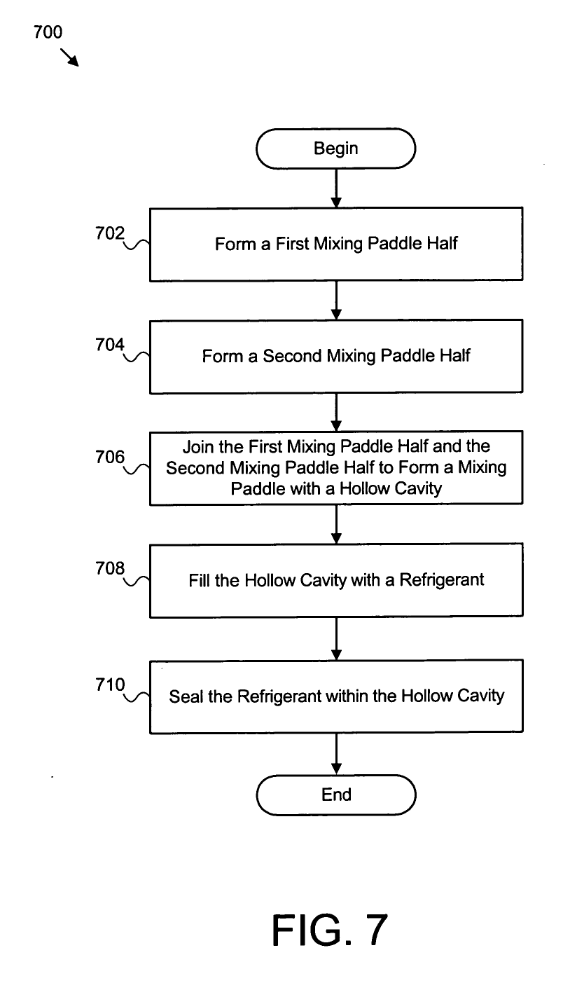

FIG. 7 is a flow chart diagram illustrating a method 700 for making a mixing paddle 202 to cool a mixture 216 (See FIG. 2). The method 700 begins by forming 702 a first mixing paddle half. The method 700 continues by forming 704 a second mixing paddle half. The first mixing paddle half and the second mixing paddle half may be joined 706 to form a mixing paddle 202 with a hollow cavity 212. Additionally, an opening may be formed in the mixing paddle 202 to allow the hollow cavity 212 to be filled 708 with a refrigerant 214. Finally, the refrigerant 214 is sealed within the hollow cavity 212 and the method 700 ends. The seal may be permanent or may be designed to allow later access. Such a nonpermanent seal may be useful in changing or replenishing the refrigerant 214.

Alternative embodiments may include forming a universal adapter in the shaft 208 of the mixing paddle 202. Also, a monitoring device 312 (FIG. 3), such as a window, may be formed in the mixing paddle 202.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A mixing paddle for cooling a mixture, the mixing paddle comprising:
a shaft configured to connect to a mixer;
a blade connected to the shaft, the blade comprising a hollow cavity; and
a refrigerant sealed within the hollow cavity.

2. The mixing paddle of claim 1, wherein the shaft comprises a universal adapter, the universal adapter configured to interchangeably connect to a mixer.

3. The mixing paddle of claim 1, wherein the hollow cavity extends into the shaft.

4. The mixing paddle of claim 1, wherein the refrigerant is in a state capable of absorbing thermal energy by conduction.

5. The mixing paddle of claim 4, wherein the state of the refrigerant is selected from the group consisting of a solid, liquid, and gas.

6. The mixing paddle of claim 1, wherein the hollow cavity is sized to accommodate expansion of the refrigerant during state phase changes.

7. The mixing paddle of claim 1, further comprising a monitoring device configured to monitor the thermal condition of the refrigerant.

8. A system for cooling a mixture comprising:
a mixer;
a container for holding a mixture; and
a mixing paddle configured to cool a mixture, the mixing paddle including a shaft configured to connect to the mixer, a blade having a hollow cavity, and a refrigerant sealed within the hollow cavity.

9. The system of claim 8, wherein the mixing paddle further comprises a universal adapter formed in the shaft, the universal adapter configured to interchangeably connect to a mixer.

10. The system of claim 8, wherein the hollow cavity extends into the shaft.

11. The system of claim 8, wherein the refrigerant is in a state capable of absorbing thermal energy by conduction.

12. The system of claim 8, wherein the hollow cavity is sized to accommodate expansion of the refrigerant during state phase changes.

13. The system of claim 8, wherein the mixing paddle further comprises a monitoring device to monitor the thermal condition of the refrigerant.

14. The system of claim 13, wherein the monitoring device comprises a thermometer.

15. The system of claim 13, wherein the monitoring device comprises a window configured to show the refrigerant within the hollow cavity.

16. A method for making a mixing paddle to cool a mixture, the method comprising:
forming a first mixing paddle half;
forming a second mixing paddle half;
joining the first mixing paddle half and the second mixing paddle half to form a mixing paddle, the mixing paddle comprising a hollow cavity; and
sealing a refrigerant within the hollow cavity.

17. The method of claim 16, further comprising forming an opening in the mixing paddle, the opening providing access to the hollow cavity.

18. The method of claim 16, further comprising filling the hollow cavity with a refrigerant.

19. The method of claim 16, wherein the mixing paddle further comprises a universal adapter for interchangeably connecting to different mixers.

20. The method of claim 16, further comprising forming a window configured to show the refrigerant within the hollow cavity.

21. A method for using a mixing paddle to cool a mixture, the method comprising:
providing a mixing paddle comprising:
a shaft configured to connect to a mixer;
a blade comprising a hollow cavity; and
a refrigerant sealed within the hollow cavity;
selecting the mixing paddle such that the refrigerant is configured to provide a predetermined rate of cooling and placing the mixing paddle in a cooling apparatus;
removing the mixing paddle from the cooling apparatus and connecting the mixing paddle to a mixer; and
mixing a mixture with the mixing paddle and periodically monitoring the temperature of the mixture until a desired temperature is reached.

22. The method of claim 21, further comprising monitoring the thermal condition of the refrigerant.

23. The method of claim 21, further comprising replacing the mixing paddle in the mixture with a second mixing paddle having a refrigerant in a state capable of absorbing additional thermal energy from the mixture.

24. The method of claim 21, wherein the refrigerant is selected from the group consisting of water, alcohol, and glycerol.
